(19) United States
(12) Patent Application Publication
(10) Pub. No.: US 2025/0343926 A1
(43) Pub. Date: Nov. 6, 2025

(54) Chroma-From-Luma Prediction With Derived Scaling Factor

(71) Applicant: Google LLC, Mountain View, CA (US)

(72) Inventors: Jianle Chen, San Diego, CA (US); Debargha Mukherjee, Cupertino, CA (US)

(21) Appl. No.: 18/854,446

(22) PCT Filed: May 19, 2023
(86) PCT No.: PCT/US2023/022889

§ 371 Date: Oct. 4, 2024

Related U.S. Application Data
(60) Provisional application No. 63/344,033, filed on May 19, 2022.

(51) Int. Cl. H04N 19/186; H04N 19/105; H04N 19/593; H04N 19/70

(52) U.S. Cl. CPC H04N 19/186; H04N 19/105; H04N 19/593; H04N 19/70

(57) ABSTRACT

Chroma-from-luma (CfL) intra prediction mode is described that allows for a derived scaling factor. A luma block is reconstructed from an encoded bitstream. An average luminance value for luma pixel values and difference values between the luma pixel values and the average luminance value are determined. An average chrominance value for a chroma block is determined. From a flag in the encoded bitstream, whether a scaling factor for the mode is explicitly signaled or should be derived is determined. Deriving the scaling factor uses pixel values of at least one neighboring block, and otherwise the scaling factor is determined from the encoded bitstream. The scaling factor is applied to the difference values to obtain scaled difference values, a CfL prediction block is obtained by adding the average chrominance value to the scaled difference values, and the chroma block is reconstructed by adding the CfL prediction block to a residual block.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

One technique for compression uses a reference frame to generate a prediction block corresponding to a current block to be encoded. Differences between the prediction block and the current block can be encoded, instead of the values of the current block themselves, to reduce the amount of data encoded.

### SUMMARY

This disclosure relates generally to encoding and decoding video data and more particularly relates to predicting chroma values from luma values for video compression that includes an option for a derived scaling factor.

According to an aspect of the teachings herein, a method includes reconstructing, from an encoded bitstream, a luma block of a current block of an image, determining an average luminance value for luma pixel values of the luma block, determining difference values between the luma pixel values and the average luminance value, determining an average chrominance value for a chroma block of the current block, deriving a scaling factor from pixel values of at least one neighboring block, applying the scaling factor to the difference values to obtain scaled difference values, obtaining a chroma-from-luma prediction block by adding the average chrominance value to the scaled difference values, and reconstructing the chroma block by adding the chroma-from-luma prediction block to a residual block for the chroma block.

According to another aspect of the teachings herein, a method includes reconstructing, from an encoded bitstream, a luma block of a current block of an image, determining an average luminance value for luma pixel values of the luma block, determining difference values between the luma pixel values and the average luminance value, determining an average chrominance value for a chroma block of the current block, determining, from a flag in the encoded bitstream, whether a scaling factor for intra-prediction is explicitly signaled or should be derived, responsive to determining that the scaling factor should be derived, deriving a scaling factor from pixel values of at least one neighboring block, and otherwise determining the scaling factor from the encoded bitstream, applying the scaling factor to the difference values to obtain scaled difference values, obtaining a chroma-from-luma prediction block by adding the average chrominance value to the scaled difference values, and reconstructing the chroma block by adding the chroma-from-luma prediction block to a residual block for the chroma block.

According to another aspect of the teachings herein, a method includes reconstructing, from an encoded bitstream, a luma block of a current block of an image, determining an average luminance value for luma pixel values of the luma block, determining difference values between the luma pixel values and the average luminance value, determining an average chrominance value for a chroma block of the current block, determining, from a flag in the encoded bitstream, that a scaling factor for intra-prediction is explicitly signaled, responsive to determining that the scaling factor is explicitly signaled, determining the scaling factor from the encoded bitstream, applying the scaling factor to the difference values to obtain scaled difference values, obtaining a chroma-from-luma prediction block by adding the average chrominance value to the scaled difference values, and reconstructing the chroma block by adding the chroma-from-luma prediction block to a residual block for the chroma block.

According to yet another aspect of the teachings herein, a method includes reconstructing, from an encoded bitstream, a luma block of a current block of an image, determining an average luminance value for luma pixel values of the luma block, determining difference values between the luma pixel values and the average luminance value, determining an average chrominance value for a chroma block of the current block, determining, from a flag in the encoded bitstream, that a scaling factor for intra-prediction should be derived, responsive to determining that the scaling factor should be derived, deriving the scaling factor from pixel values of at least one neighboring block, applying the scaling factor to the difference values to obtain scaled difference values, obtaining a chroma-from-luma prediction block by adding the average chrominance value to the scaled difference values, and reconstructing the chroma block by adding the chroma-from-luma prediction block to a residual block for the chroma block.

In some implementations, determining the average luminance value for the luma pixel values of the luma block comprises averaging subsampled luma pixel values of the luma block of the current block.

In some implementations, determining the average chrominance value for the chroma block of the current block comprises averaging chroma pixel values of at least one neighboring chroma block, and determining the average luminance value for the luma pixel values of the luma block comprises averaging luma pixel values of at least one luma block corresponding to the at least one neighboring chroma block.

In some implementations, determining the average luminance value for luma pixel values of the luma block comprises determining the average luminance value using a first technique responsive to determining that the scaling factor should be derived, and determining the average luminance value using a second technique responsive to determining that the scaling factor is explicitly signaled. In some variations of these implementations, the first technique comprises averaging subsampled luma pixel values of at least one neighboring luma block, and the second technique comprises averaging subsampled luma pixel values of the luma block of the current block.

In some implementations, the chroma block is a first chroma block of the current block, and the flag indicates how to determine the scaling factor for each of the first chroma block and a second chroma block of the current block.

In some implementations, the chroma block is a first chroma block of the current block, the flag is a first flag, and the encoded bitstream includes a second flag that indicates how to determine a scaling factor for a second chroma block of the current block.

In some implementations, deriving the scaling factor comprises deriving the scaling factor based on a relationship between pixel values of neighboring reconstructed chroma pixels and pixel values of their corresponding downsampled luma pixels.

In some implementations, deriving the scaling factor comprises deriving the scaling factor α by determining a scaling factor that minimizes the value of Sum(Rec_{C}−α·Rec_{γ})², Rec_{C} represents respective pixel values of the neighboring reconstructed chroma pixels, and Rec_{γ} represents respective pixel values of neighboring downsampled luma values co-located with the neighboring reconstructed chroma pixels.

In some implementations, determining the scaling factor from the encoded bitstream comprises deriving a predictor for the scaling factor from the pixel values of the at least one neighboring block, decoding a residual for the scaling factor from the encoded bitstream, and adding the predictor for the scaling factor to the residual for the scaling factor to obtain the scaling factor. In some variations of these implementations, deriving the scaling factor comprises deriving the scaling factor α by minimizing the function Sum(Rec_{C}−α·Rec_{γ})², Rec_{C} represents respective pixel values of neighboring reconstructed chroma pixels, and Rec_{γ} represents respective pixel values of neighboring downsampled luma values co-located with the neighboring reconstructed chroma pixels.

Another aspect of the teachings herein is a method that includes encoding, into an encoded bitstream, a luma block of a current block of an image, and, for a chroma block of the current block predicted using a chroma-from-luma intra prediction mode, deriving a chroma-from-luma prediction block from co-located reconstructed luma pixel values of the luma block and a linear model that uses a scaling factor, determining a residual for the chroma block using the chroma-from-luma prediction block, encoding the residual for the chroma block into the encoded bitstream, encoding a flag into the encoded bitstream that determines whether the scaling factor for the chroma-from-luma intra prediction mode is explicitly signaled or should be derived, and responsive to the flag determining that the scaling factor is explicitly signaled, encoding the scaling factor into the encoded bitstream. The method also includes transmitting or storing the encoded bitstream.

In some implementations of this method, the chroma block is a first chroma block of the current block, the flag is a first flag, and the method comprises encoding a second flag into the encoded bitstream that indicates how to determine a scaling factor for a second chroma block of the current block.

This disclosure also teaches aspects of an apparatus that can perform any of the methods described herein and aspects of a computer-readable storage medium storing instructions for performing any of the methods described herein.

These aspects of the present disclosure and variations thereof are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views unless otherwise noted.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is a block diagram of an example of the inputs and outputs of chroma-from-luma prediction.

FIG. 7 is a flowchart diagram of a process for chroma-from-luma prediction.

### DETAILED DESCRIPTION

A video stream can be compressed by a variety of techniques to reduce bandwidth required transmit or store the video stream. A video stream can be encoded into a bitstream, which involves compression, which is then transmitted to a decoder that can decode or decompress the video stream to prepare it for viewing or further processing. Compression of the video stream often exploits spatial and temporal correlation of video signals through spatial and/or motion compensated prediction. Intra-prediction, for example, uses pixels from one or more blocks spatially near a current block to be encoded to generate a block (also called a prediction block) that resembles the current block. By encoding the difference between the two blocks, a decoder receiving the encoded signal can re-create the current block.

Multiple intra-prediction modes are available. For example, multiple directional intra-prediction modes may be available that propagate pixel values adjacent to the current block in horizontal, vertical, diagonal, etc., directions, to form a prediction block for the current block. Non-directional intra-prediction modes are also possible. Non-directional intra-prediction modes generate pixel values for the prediction blocks using defined rules/formulas that do not propagate pixels in a (e.g., single) direction.

The efficacy of a prediction block (and hence the corresponding prediction mode) when used to encode or decode a block within a current frame can be measured based on a resulting signal-to-noise ratio or other measures of rate-distortion.

An image or frame is represented by pixels in red-green-blue (RGB) color format, or some other color format. One particularly desirable color format is a luma-chrominance format, where brightness of the image or frame is represented by a luma (Y or Y′) component, and the color components of the image are represented by two chrominance or chroma values, generally abbreviated Cb and Cr, Cb′ and Cr′, or U and V. Herein, YCbCr is used to represent this format.

Whatever color format is used, each plane of color data may be compressed and encoded separately. In practice, however, there may be some correspondence between the planes of data for a block. For example, an intra-prediction mode may be used that derives chroma prediction samples from luma samples. Stated differently, a prediction block for compression of a block in the chroma plane of image data may be generated using pixels from a corresponding block in the luma plane. This may be referred to as chroma-from-luma prediction.

Further details of chroma-from-luma prediction are described herein with initial reference to a system in which the teachings herein can be implemented.

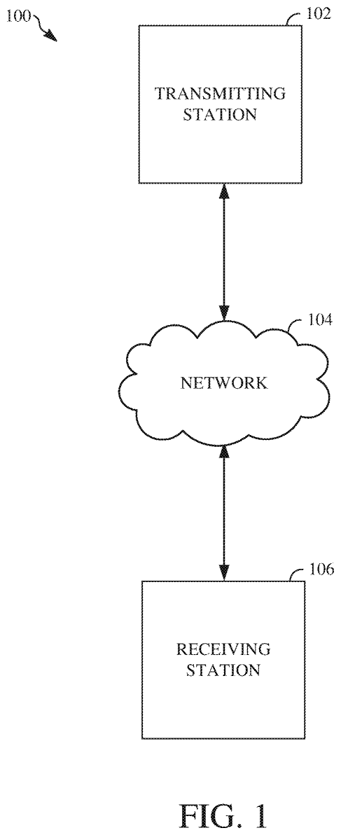

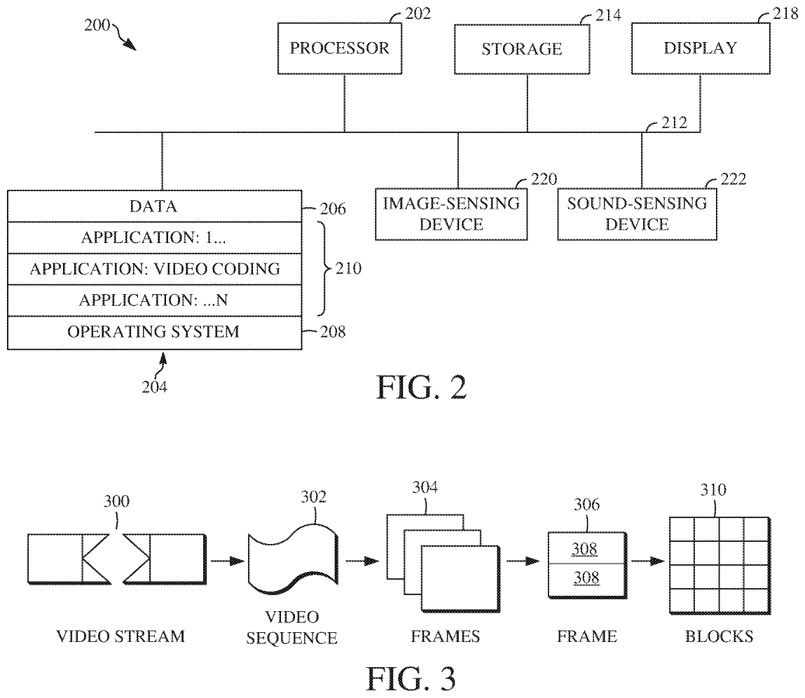

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having a non-transitory storage medium or memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on Hypertext Transfer Protocol (HTTP) based.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device or non-transitory storage medium can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

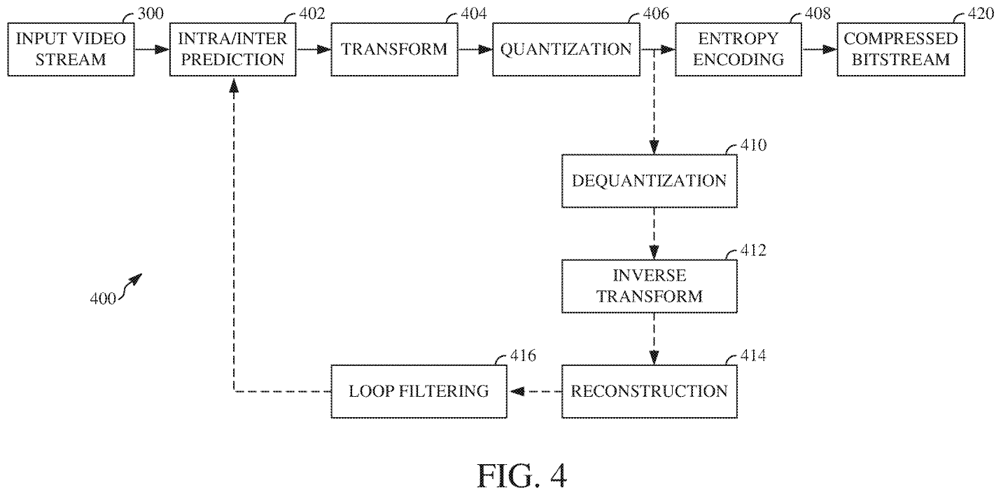

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. The designation of reference frames for groups of blocks is discussed in further detail below.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs similar functions to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

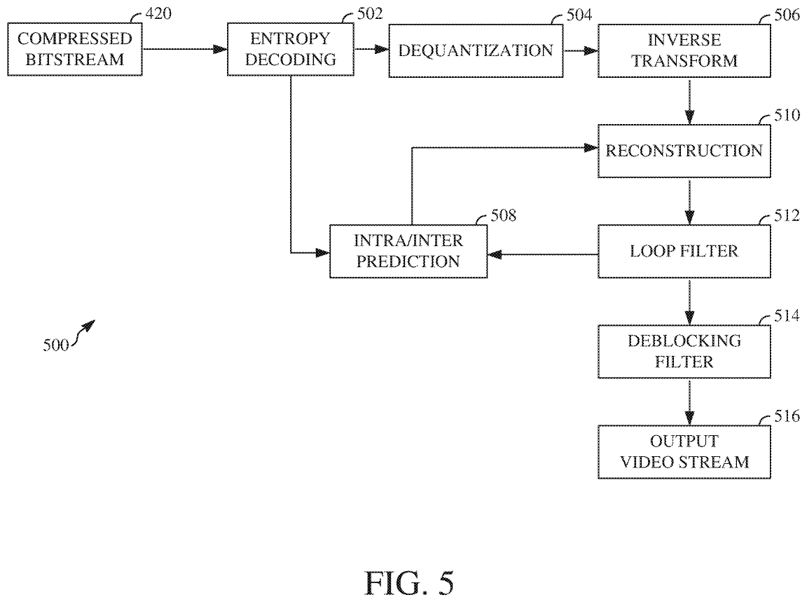

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

As initially described, chroma-from-luma prediction is an available intra-prediction mode solely for chroma blocks. Next described are details of using this intra-prediction mode for encoding and decoding.

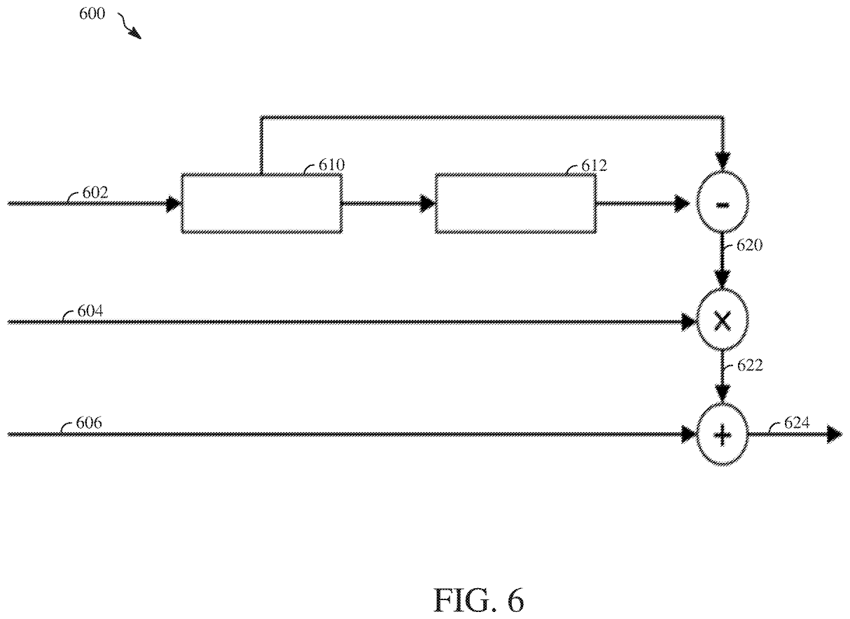

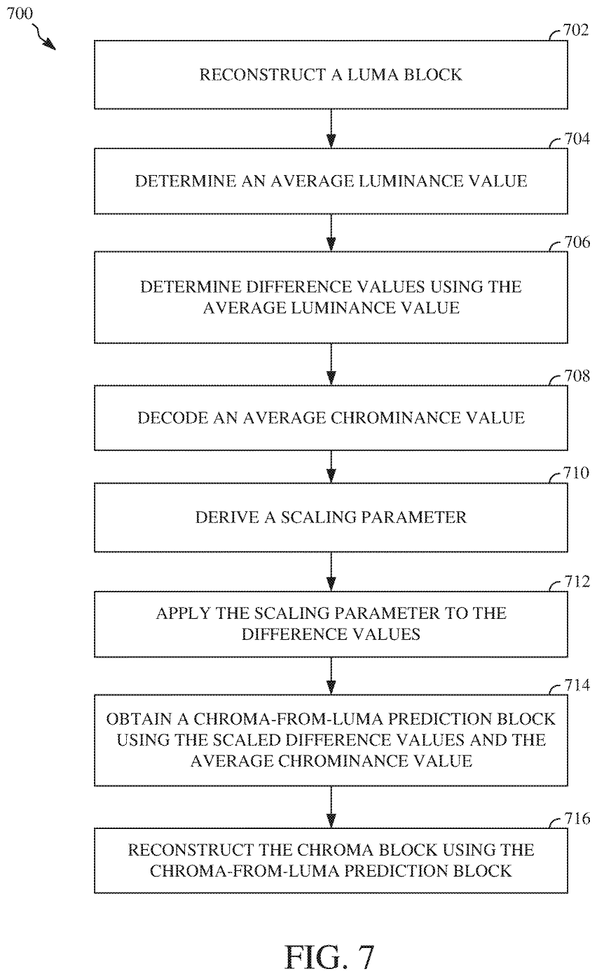

FIG. 6 is a block diagram 600 of an example of the inputs and outputs of chroma-from-luma prediction. FIG. 7 is a flowchart diagram of a method or process 700 for chroma-from-luma prediction. The process 700 can be implemented, for example, as a software program that may be executed by computing devices such as transmitting station 102 or receiving station 106. For example, the software program can include machine-readable instructions that may be stored in a memory such as the memory 204 or the secondary storage 214, and that, when executed by a processor, such as CPU 202, may cause the computing device to perform the process 700. The process 700 can be implemented using specialized hardware or firmware. Some computing devices may have multiple memories or processors, and the operations described in the process 700 can be distributed using multiple processors, memories, or both. In some implementations, the process 700 may be performed at a decoder, such as the decoder 500.

FIG. 6 schematically illustrates the process 700 of FIG. 7, and these figures are described concurrently.

The inputs into the process 700 include reconstructed luma samples 602, a scaling factor 604, and a chroma DC prediction 606. The process 700 assumes that an encoded bitstream, such as the compressed bitstream 420, has been received by the decoder for reconstruction of an image. The image may be a frame in a video sequence in some implementations. The process 700 describes an intra-prediction process for a chroma block. A single luma block is, however, associated with two chroma blocks. Thus, the process 700 can be repeated for each of the two chroma blocks of a current block to be decoded.

At 702, a luma block of a current block of the image is reconstructing from the encoded bitstream. As described in more detail in FIG. 5 above, reconstruction of the luma block can include entropy decoding quantized coefficients for the luma block, dequantizing the quantized coefficients to obtain transform coefficients, inverse transforming the transform coefficients to obtain a residual block, generating a prediction block using information from the encoded bitstream, and reconstructing the luma block by adding the residual block and the prediction block on a pixel-by-pixel basis. The prediction mode for generating the prediction block may be signaled in a header of the frame, slice, block, etc., by the encoder. The reconstructed luma block (unfiltered or filtered using an in-loop filter) provides the reconstructed luma samples 602 for the chroma-from-luma prediction. The reconstructed luma samples 602 provide luma pixel values and may also be referred to as luma pixel values herein.

At 704, an average luminance value for luma pixel values of the luma block is determined. The average value may also be referred to as a DC value or a luma DC value of the block. Each luma pixel value may comprise a DC value (or DC contribution to the sample) and an AC value (or AC contribution to the sample). At 706, difference values between the luma pixel values and the average luminance value are determined. Stated differently, the AC contribution to the luma block is determined by removing the DC contribution from the luma block. This may be done by subtracting the average luminance value from respective luma pixel values of the reconstructed luma block. The difference values thus represent the AC contribution to the luma block.

In some implementations, the chroma block and the luma block may be at different resolutions. This can occur because the human eye is more sensitive to brightness than to color. By subsampling the chroma blocks, image data may be reduced for encoding and subsequent decoding. Common chroma subsampling formats include, for example, 4:2:0 and 4:2:2 chroma subsampling formats. In calculating the chroma prediction samples as described below, it is desirable that the reconstructed luma samples be co-located with the chroma prediction samples. That is, their pixel addresses are the same within the current block. Where the image and/or the current block has chroma subsampling, and referred to FIG. 6, it is desirable that luma reconstructed samples be input to a sub-sampler 610, and the resulting sub-sampled luma pixel values be used to determine the average luminance value at the average calculator 612. As a result, the difference values 620 determined at 706 may be a subsampled AC contribution to the luma block (e.g., subsampled luma values).

Generally, the chroma-from-luma prediction block is derived as the sum of a chroma DC contribution and a scaled luma AC contribution. At 708, an average chrominance value for a chroma block of the current block is determined. The average chrominance value may be decoded from the encoded bitstream or predicted from the encoded bitstream. The average chrominance value may also be referred to as chroma DC value of the block. Each chroma pixel value may comprise a DC value (or DC contribution to the sample) and an AC value (or AC contribution to the sample). The average chrominance value may correspond to the chroma DC prediction 606. That is, like the luma block, the chroma block may be reconstructed by, and as described in more detail in FIG. 5 above, entropy decoding quantized coefficients for the chroma block, dequantizing the quantized coefficients to obtain transform coefficients, and inverse transforming the transform coefficients to obtain a residual block added to a prediction block. In this case, the encoder and decoder may predict the DC contribution to the sample (the chroma DC prediction 606) as described below or the encoder may encode the DC contribution into the encoded bitstream as a residual, for example, which is used to generate a chroma-from-luma prediction block. In some implementations, the average chrominance value is determined at 708 by the average of the neighboring chroma samples. That is, additional signaling for the chroma block of the current block is not required. Instead, the average chrominance values may be determined by averaging chrominance values of one or more previously reconstructed chroma blocks that neighbor the current block (e.g., are spatially adjacent to the current block and/or to the chroma block of the current block).

The final input into the chroma-from-luma prediction is the scaling factor 604 (also called a scaling parameters), which may be represented by the variable a. At 710, the scaling parameter or scaling factor is determined. A scaling factor may be expressly signaled in the bitstream or may be derived. Accordingly, if the scaling factor is expressly signaled, the scaling factor may be determined from the encoded bitstream (e.g., from a header) In some implementations, a scaling factor may be signaled or derived separately for each of the chroma blocks or a single scaling factor may be used for each of the two chroma blocks associated with a luma block. In these implementations, the determination of a scaling factor is performed at an encoder, e.g., as part of a rate distortion loop or on an ad hoc basis. Additional benefits to reducing the size of the bitstream may be achieved by deriving the scaling factor at both the encoder and the decoder such that the scaling factor does not have to be signaled.

The scaling factor may be derived implicitly instead of being explicitly signaled in the bitstream by using neighboring reconstructed chroma samples Rec_{C} (e.g., chroma pixel values from an adjacent chroma block) and their corresponding (e.g., co-located) luma samples Rec_{γ} (e.g., downsampled luma values). For example, a least square error or some other technique that defines a relationship of neighboring luma and chroma values may be used. More specifically, the scaling factor may be derived so as to minimizes differences between pixel values of the neighboring reconstructed chroma pixels and pixel values of their corresponding downsampled luma pixels. For example, the least square error may be represented by the following equation (and solving for the variable a as the scaling factor 604 by minimizing the function Sum).

$${Sum ( {Rec}_{C} - α \cdot {Rec}_{Y} )}^{2} \qquad ( 1 )$$

Once the scaling factor is determined at 710, it may be applied to the difference values at 712 to obtain scaled AC luma values (scaled luma AC contribution) 622. Multiplication may occur by multiplying each of the difference values 620 by the scaling factor to obtain scaled difference values.

At 714, a chroma-from-luma prediction block 624 is obtained by adding the average chrominance value (e.g., the chroma DC prediction 606) to the scaled difference values (e.g., the scaled AC luma values).

Mathematically, a predicted chroma pixel value Pred_{C} of the chroma-from-luma prediction block 624 may be represented by the following equation.

$${Pred}_{C} = α \cdot ( {Rec}_{Y} - {DC}_{Y} ) + {DC}_{C} \qquad ( 2 )$$

In equation (2), DC_{γ} may be the average of the current (e.g., downsampled) reconstructed luma block and DC_{C} may be the average of the neighboring chroma samples. Alternatively, DC_{γ} can be calculated based on the neighboring (e.g., downsampled) reconstructed luma samples to match the samples for the calculation of DC_{C}. Using the neighboring (e.g., downsampled) reconstructed luma samples to derive DC_{γ} may be used for both an explicit chroma-from-luma prediction mode (i.e., where α is explicitly signaled) and the implicit chroma-from-luma prediction mode (i.e., where α is derived as described above). In some implementations, different techniques may be used to determine DC_{γ} for the explicit mode as compared to the implicit mode. For example, DC_{γ} for the explicit mode can be set as the average of the current (e.g., downsampled) reconstructed luma block, and DC_{γ} for the implicit mode (i.e., for the derived scaling factor) can be set as the average of the neighboring (e.g., downsampled) reconstructed luma samples.

In this way, the chroma-from-luma mode with the scaling factor α derived implicitly can work together with an explicit signaling method. In an example, a flag can be signaled to indicate whether a derived scaling factor is applied or is explicitly signaled. The flag can be signaled jointly for Cb and Cr components, or individually for Cb and Cr components. In another embodiment, the derived scaling factor can be used as the predictor of an explicitly signaled value for the scaling factor. For example, the delta (difference) between the current scaling factor and the implicitly derived scaling factor may be signaled.

The chroma-from-luma prediction block 624 may be used at 716 to reconstruct the chroma block by adding it to a residual block for the chroma block that is decoded from the encoded bitstream.

In encoding according to a chroma-from-luma intra prediction mode described herein, the encoder encodes, into an encoded bitstream, a luma block of a current block of an image. Like the decoder, the image can be a still image or a frame of a video sequence. A chroma-from-luma prediction block can be derived from co-located reconstructed luma pixel values of the luma block and a linear model that uses a scaling factor as described with regards to FIG. 6. Thereafter, a residual for the chroma block using the chroma-from-luma prediction block can be determined (e.g., by subtracting the chroma-from-luma prediction block from the chroma block). The residual for the chroma block is encoded into the encoded bitstream. A flag is encoded into the encoded bitstream that determines whether the scaling factor for the chroma-from-luma intra prediction mode is explicitly signaled or should be derived. Where the flag indicates that the scaling factor is explicitly signaled, the scaling factor can be encoded into the encoded bitstream. The encoded bitstream is transmitted or stored (e.g., for later decoding by a decoder).

The encoded or compressed bitstream may be stored in a non-transitory storage medium and includes, for respective current blocks of an image using the chroma-from-luma intra prediction mode, an encoded luma block (i.e., entropy encoded transform coefficients of a residual generated from a luma block of the current block, whether those transform coefficients are quantized or un-quantized), a header for the encoded luma block that includes the information needed to decode the encoded luma block, including the prediction mode used to generate a prediction block used to determine the residual of the luma block, a flag that indicates that the luma-from-chroma intra prediction mode was used to encode a residual for a chroma block of the current block, and a flag that indicates whether the scaling parameter is to be derived or whether the scaling parameter is expressly signaled. If the flag indicates that the scaling parameter is expressly signaled, the encoded bitstream also includes the entropy encoded scaling parameter or an entropy encoded residual of the scaling parameter. In either event, the encoded chroma block of the current block is included in the encoded bitstream. The encoded chroma block comprises entropy encoded transform coefficients of the residual that is the difference between the chroma-from-luma prediction block generated using the scaling parameter and the chroma block of the current block, whether those transform coefficients are quantized or un-quantized. In general, an encoded second chroma block is also included. The flag that indicates whether the scaling parameter is to be derived or whether the scaling parameter is expressly signaled can also apply to the second chroma block, or another such flag for the second chroma block may also be included in the encoded bitstream, optionally followed by a second encoded scaling factor depending on the value of the flag.

The encoder can determine the value of the flag(s)—that is, whether the scaling factor is explicitly signaled or derived—according to any technique. For example, the encoder may derive the luma-from-chroma prediction block using multiple values for the scaling vector including a predefined formula or equation shared with the decoder for determining the derived scaling vector. This may be performed as part of a conventional rate-distortion optimization to determine the best prediction mode for the current block.

The availability of a derived scaling factor as described herein allows different values for the chroma-from-luma prediction block, which can improve coding efficiency in the chroma-from-luma intra prediction mode. Moreover, and as described with regards to the description of the bitstream above, the teachings herein can eliminate and/or reduce express signaling of a scaling factor in the chroma-from-luma intra prediction mode.

For simplicity of explanation, each of the processes is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized that contains other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

1. An apparatus for decoding, comprising:
a processor configured to:
reconstruct, from an encoded bitstream, a luma block of a current block of an image;
determine an average luminance value for luma pixel values of the luma block;
determine difference values between the luma pixel values and the average luminance value;
determine an average chrominance value for a chroma block of the current block;
determine, from a flag in the encoded bitstream, whether a scaling factor for a chroma-from-luma intra prediction mode is explicitly signaled or should be derived;
responsive to determining that the scaling factor should be derived, derive a scaling factor from pixel values of at least one neighboring block, and otherwise determine the scaling factor from the encoded bitstream;
apply the scaling factor to the difference values to obtain scaled difference values;
obtain a chroma-from-luma prediction block by adding the average chrominance value to the scaled difference values; and
reconstruct the chroma block by adding the chroma-from-luma prediction block to a residual block for the chroma block.

2. The apparatus of claim 1, wherein to determine the average luminance value for the luma pixel values of the luma block comprises to average subsampled luma pixel values of the luma block of the current block.

3. The apparatus of claim 1, wherein:
to determine the average chrominance value for the chroma block of the current block comprises to average chroma pixel values of at least one neighboring chroma block; and
to determine the average luminance value for the luma pixel values of the luma block comprises to average luma pixel values of at least one luma block corresponding to the at least one neighboring chroma block.

4. The apparatus of claim 1, wherein to determine the average luminance value for luma pixel values of the luma block comprises to:
determine the average luminance value using a first technique responsive to determining that the scaling factor should be derived; and
determine the average luminance value using a second technique responsive to determining that the scaling factor is explicitly signaled.

5. The apparatus of claim 4, wherein:
the first technique comprises averaging subsampled luma pixel values of at least one neighboring luma block; and
the second technique comprises averaging subsampled luma pixel values of the luma block of the current block.

6. The apparatus of claim 1, wherein:
the chroma block is a first chroma block of the current block; and
the flag indicates how to determine the scaling factor for each of the first chroma block and a second chroma block of the current block.

7. The apparatus of claim 1, wherein:
the chroma block is a first chroma block of the current block;
the flag is a first flag; and
the encoded bitstream includes a second flag that indicates how to determine a scaling factor for a second chroma block of the current block.

8. The apparatus of claim 1, wherein to derive the scaling factor comprises to derive the scaling factor as a value that minimizes differences between pixel values of neighboring reconstructed chroma pixels and pixel values of their corresponding downsampled luma pixels.

9. The apparatus of claim 1, wherein:
to derive the scaling factor comprises to derive the scaling factor α by minimizing Sum(Rec_{C}−α·Rec_{γ})²;
Rec_{C} represents respective pixel values of the neighboring reconstructed chroma pixels; and
Rec_{γ} represents respective pixel values of neighboring downsampled luma values co-located with the neighboring reconstructed chroma pixels.

10. The apparatus of claim 1, wherein to determine the scaling factor from the encoded bitstream comprises to:
derive a predictor for the scaling factor from the pixel values of the at least one neighboring block;
decode a residual for the scaling factor from the encoded bitstream; and
add the predictor for the scaling factor to the residual for the scaling factor to obtain the scaling factor.

11. The apparatus of claim 10, wherein:
to derive the predictor for the scaling factor comprises to derive the scaling factor α by minimizing Sum(Rec_{C}−α·Rec_{γ})²;
Rec_{C} represents respective pixel values of neighboring reconstructed chroma pixels; and
Rec_{γ} represents respective pixel values of neighboring downsampled luma values co-located with the neighboring reconstructed chroma pixels.

12. An apparatus for encoding, comprising:
a processor configured to:
encode, into an encoded bitstream, a luma block of a current block of an image;
for a chroma block of the current block predicted using a chroma-from-luma intra prediction mode:
derive a chroma-from-luma prediction block from co-located reconstructed luma pixel values of the luma block and a linear model that uses a scaling factor;
determine a residual for the chroma block using the chroma-from-luma prediction block;
encode the residual for the chroma block into the encoded bitstream;
encode a flag into the encoded bitstream that determines whether the scaling factor for the chroma-from-luma intra prediction mode is explicitly signaled or should be derived; and
responsive to the flag determining that the scaling factor is explicitly signaled,
encode the scaling factor into the encoded bitstream; and
transmit or store the encoded bitstream.

13. The apparatus of claim 12, wherein:
the chroma block is a first chroma block of the current block;
the flag is a first flag; and
the processor is configured to encode a second flag into the encoded bitstream that indicates how to determine a scaling factor for a second chroma block of the current block.

14. (canceled)

15. (canceled)

16. The apparatus of claim 12, wherein:
the chroma block is a first chroma block of the current block; and
the flag indicates how to determine the scaling factor for each of the first chroma block and a second chroma block of the current block.

17. A computer-readable storage medium storing an encoded bitstream, the encoded bitstream comprising an encoded luma block of a current block of an image; for a chroma block of the current block predicted using a chroma-from-luma intra prediction mode, an encoded residual determined using a chroma-from-luma prediction block derived from co-located reconstructed luma pixel values of the luma block and a linear model that uses a scaling factor; a flag that determines whether the scaling factor for the chroma-from-luma intra prediction mode is explicitly signaled or should be derived by a decoder; and, where the scaling factor is explicitly signaled, the scaling factor as encoded into the bitstream.

18. The computer-readable storage medium of claim 17, wherein the chroma block is a first chroma block of the current block, the flag is a first flag, and the encoded bitstream comprises a second flag that indicates how to determine a scaling factor for a second chroma block of the current block.

19. The computer-readable storage medium of claim 17, wherein the scaling factor as encoded comprises a residual determined using a predictor for the scaling factor derived from pixel values of the at least one neighboring block.

20. The computer-readable storage medium of claim 17, wherein the chroma block is a first chroma block of the current block; the encoded bitstream includes an encoded second chroma block of the current block; and the flag indicates how to determine the scaling factor for each of the first chroma block and a second chroma block of the current block.
